(19) United States
(12) Patent Application Publication
(10) Pub. No.: US 2026/0328336 A1
(43) Pub. Date: Oct. 22, 2026

(54) ADJUSTABLE AND FOLDABLE STAND FOR AMPLIFIERS AND SPEAKERS

(71) Applicant: Designare Products, LLC, Lyndhurst, OH (US)

(72) Inventor: Geza Kassai, Lyndhurst, OH (US)

(73) Assignee: Designare Products, LLC, Lyndhurst, OH (US)

(21) Appl. No.: 19/184,511

(22) Filed: Apr. 21, 2025

(51) Int. Cl. F16M 11/10

(52) U.S. Cl. CPC F16M 11/10; F16M 2200/022

(57) ABSTRACT

An adjustable stand for supporting an article includes a pair of shelf members configured to support the article, a pair of leg members configured to stand on a surface, and a width-adjustment mechanism configured to adjust widths between the pair of leg members. Each of the leg members is configured to support one of the shelf members. The width-adjustment mechanism includes two or more adjustable hinge assemblies connecting the pair of leg members. Each of the adjustable hinge assemblies is configured to rotatably expand to space the leg members from each other, rotatably fold to bring the leg members toward each other, and slidably adjust a respective width between the leg members when the adjustable hinge assemblies are rotatably expanded.

### FIELD OF THE INVENTION

This application relates generally to amplifier and speaker support devices, and, more particularly, to a foldable and adjustable stand for amplifiers and speakers.

### BACKGROUND OF THE INVENTION

Amplifiers and speakers used by musicians, DJs, and other audio professionals are frequently positioned directly on the ground during performances. This placement often leads to suboptimal sound projection and reduced audio clarity for the audience. While a number of support stands are commercially available to elevate or tilt sound equipment, these solutions commonly lack sufficient adjustability, broad compatibility with different amplifier and speaker models, and true portability. Additionally, many require permanent attachment or modifications to the equipment, which may not be desirable for users. Accordingly, there exists a need for a compact, portable stand capable of supporting and angling a wide range of sound equipment without requiring permanent alterations, thereby allowing users to direct sound output more effectively.

### SUMMARY OF THE INVENTION

In accordance with an embodiment of the present invention, there is provided an adjustable stand for supporting an article. The stand includes a pair of shelf members configured to support the article, a pair of leg members configured to stand on a surface, and a width-adjustment mechanism configured to adjust widths between the pair of leg members. Each of the leg members is configured to support one of the shelf members. The width-adjustment mechanism includes two or more adjustable hinge assemblies connecting the pair of leg members. Each of the adjustable hinge assemblies is configured to rotatably expand to space the leg members from each other, rotatably fold to bring the leg members toward each other, and slidably adjust a respective width between the leg members when the adjustable hinge assemblies are rotatably expanded.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1 is a perspective view illustrating an example of an adjustable stand when unfolded according to the present invention;

FIG. 2 is a perspective view illustrating an example of a first leg member of the adjustable stand according to the present invention;

FIG. 3 is a perspective view illustrating an example of a second leg member of the adjustable stand according to the present invention;

FIG. 4 is a perspective view illustrating an example of a first shelf member of the adjustable stand according to the present invention;

FIG. 5 is a perspective view illustrating an example of a second shelf member of the adjustable stand according to the present invention;

FIG. 6 is a perspective view illustrating an example of the adjustable stand when folded according to the present invention;

FIG. 7 is a perspective view illustrating an example of a first hinge member of the adjustable stand according to the present invention;

FIG. 8 is a perspective view illustrating an example of a second hinge member of the adjustable stand according to the present invention;

FIG. 9 is a perspective view illustrating an example of a third hinge member of the adjustable stand according to the present invention;

FIG. 10 is a perspective view illustrating an example of a fourth hinge member of the adjustable stand according to the present invention;

FIG. 11 is a perspective view illustrating a second example of an adjustable stand when folded according to the present invention;

FIG. 12 is a perspective view illustrating a second example of the adjustable stand when partially unfolded according to the present invention;

FIG. 13 is a perspective view illustrating a second example of the adjustable stand when unfolded according to the present invention;

FIG. 14 is a perspective view illustrating a second example of the adjustable stand when unfolded and fully widened according to the present invention;

FIG. 15 is another perspective view illustrating a second example of the adjustable stand when partially unfolded according to the present invention;

FIG. 16 is a perspective view illustrating a second example of the adjustable stand according to the present invention when an amplifier is seated on the adjustable stand at an angular position of 35°;

FIG. 17 is a perspective view illustrating a second example of the adjustable stand according to the present invention when an amplifier is seated on the adjustable stand at an angular position of 17°;

FIG. 18 is a perspective view illustrating a second example of the adjustable stand according to the present invention when an amplifier is seated on the adjustable stand at an angular position of 0°;

FIG. 19 is a perspective view illustrating a second example of a second hinge member of the adjustable stand according to the present invention;

FIG. 20 is a perspective view illustrating a second example of a third hinge member of the adjustable stand according to the present invention; and

FIG. 21 is a perspective view illustrating a second example of a fourth hinge member of the adjustable stand according to the present invention.

### DETAILED DESCRIPTION OF THE INVENTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. In addition, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Throughout this description, a slide stop 44 may be a selectively adjustable fastening device known to one having ordinary skill in the art and may include thumb screws, other types of screw/nut combinations, or any other fastening device known to one having ordinary skill in the art to be effective for adjustable, selective fastening. In any embodiments disclosed herein, the slide stop 44 can be actuated to inhibit the sliding of second hinge members 29 and 79, which will be further discussed herebelow.

Throughout this description, a fastener member 45 may be a fastening device known to one having ordinary skill in the art and may include a hinge pin, a bolt, a screw, or any other device known to one having ordinary skill in the art to be effective for rotatable fastening.

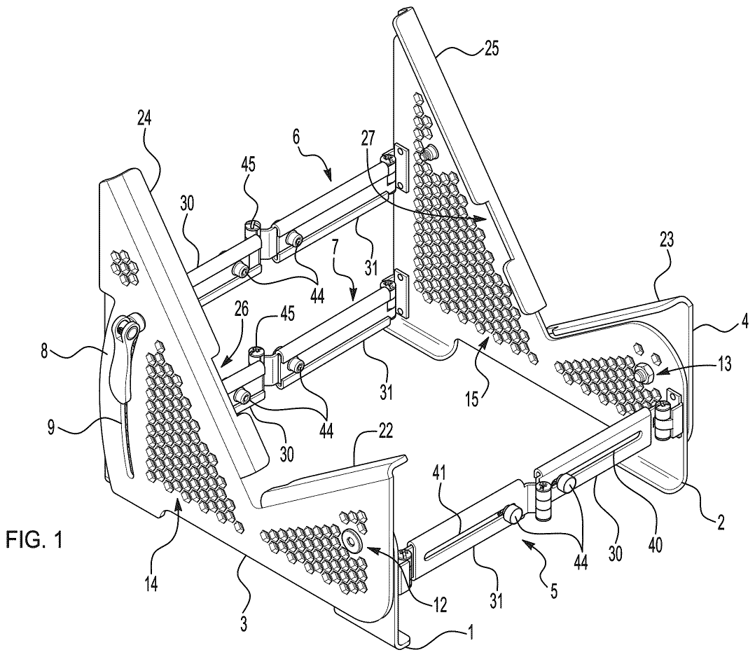

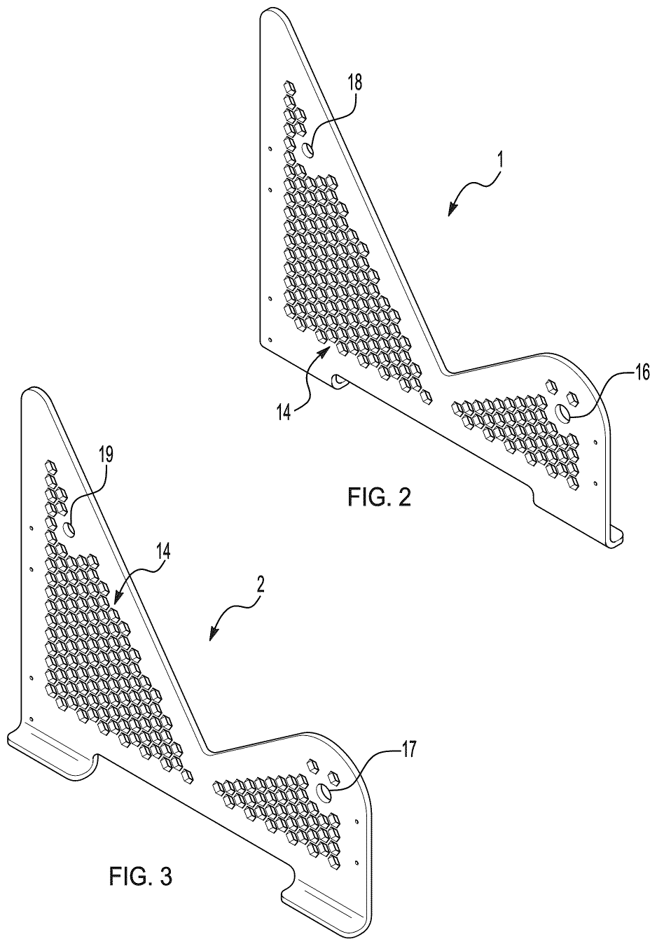

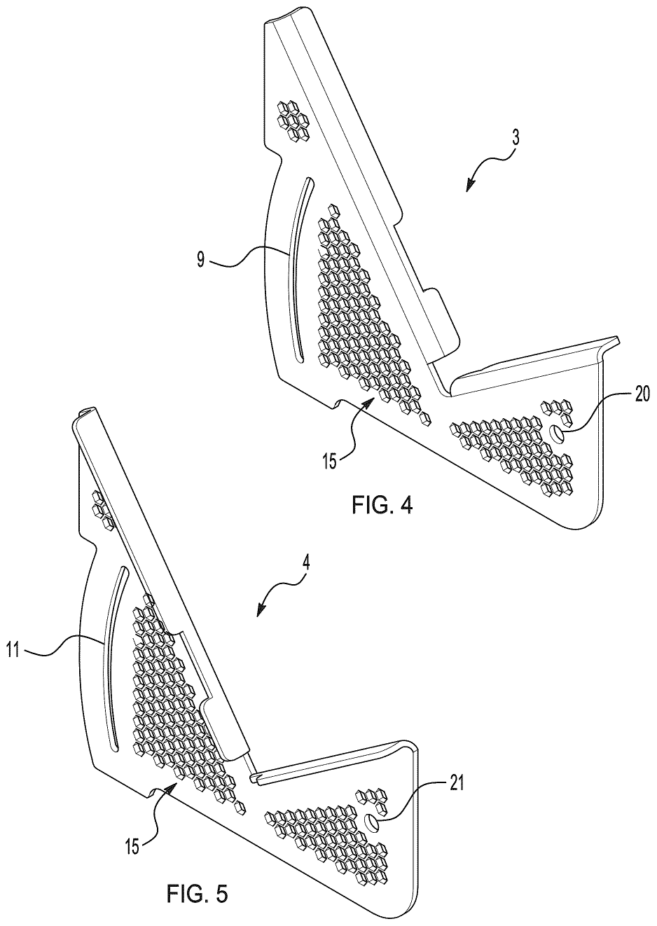

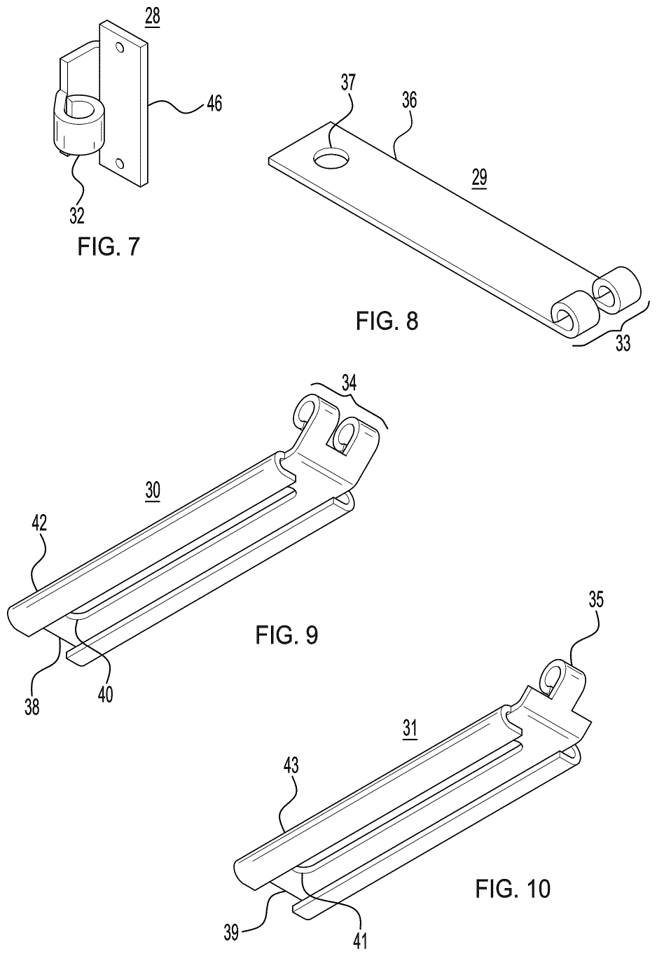

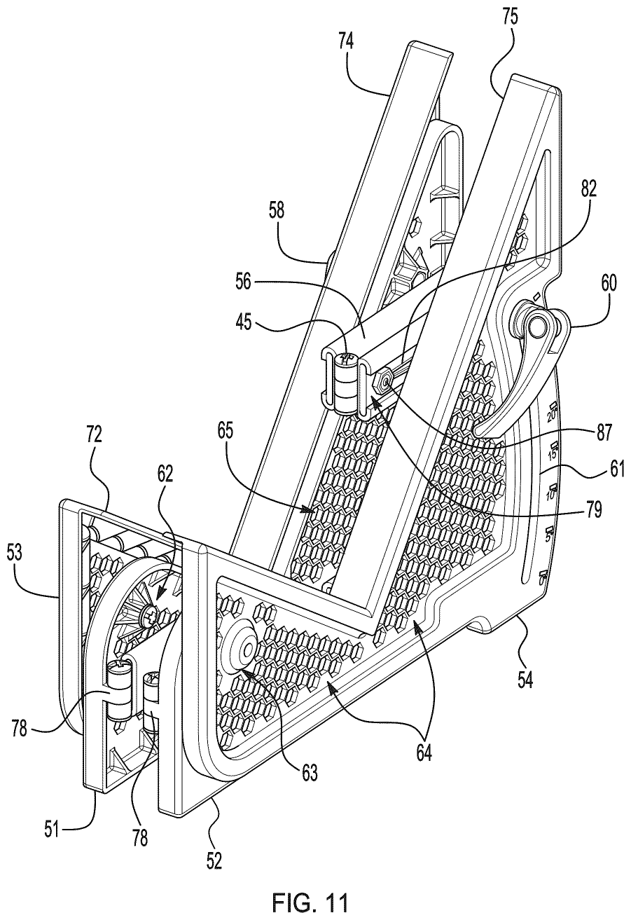

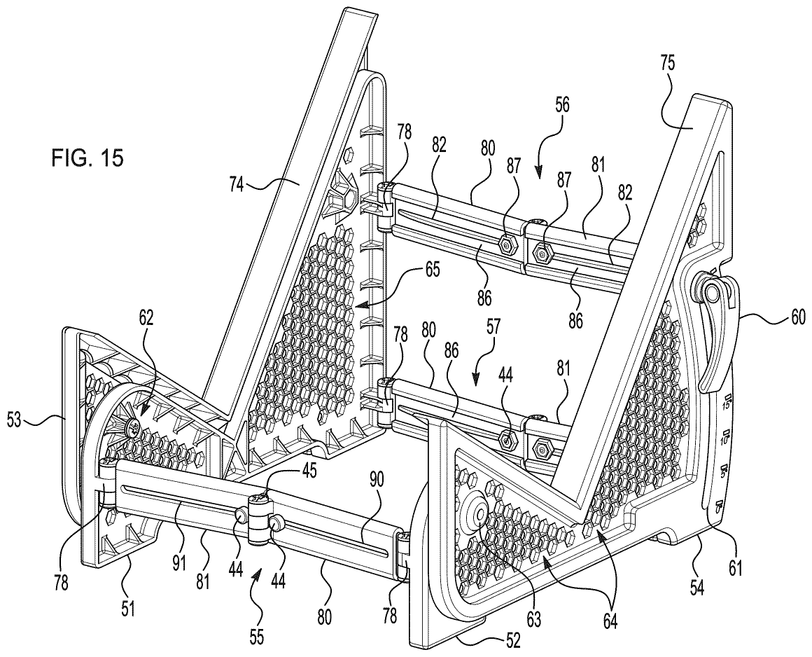

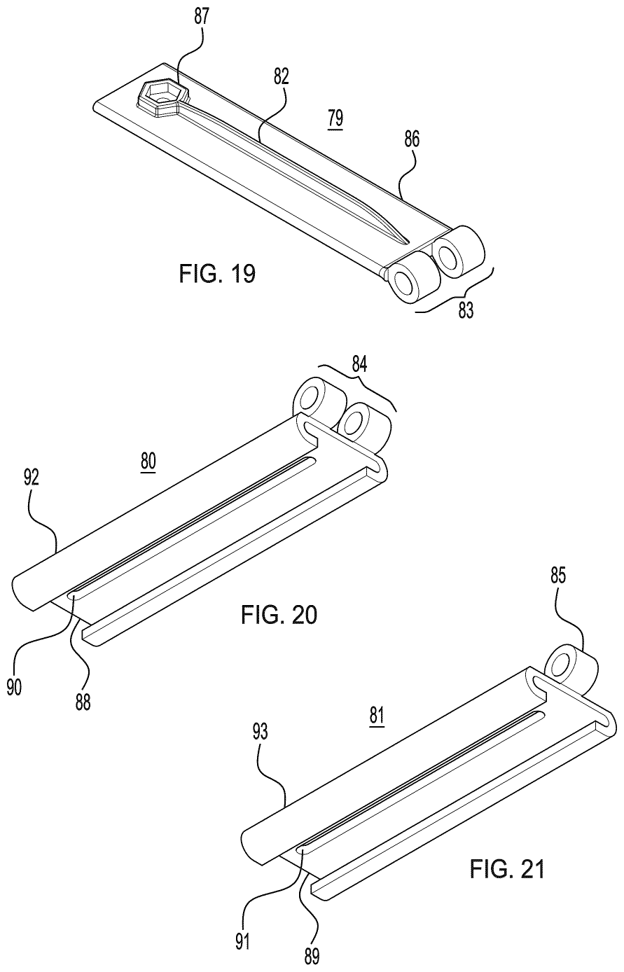

FIGS. 1-10 are perspective views illustrating an example of a metallic adjustable stand in accordance with the present invention. FIGS. 11-21 are perspective views illustrating an example of a non-metallic adjustable stand in accordance with the present invention.

It is initially noted that the functionality of the metallic adjustable stand illustrated in FIGS. 1-10 is generally the same as the functionality of the non-metallic adjustable stand illustrated in FIGS. 11-21. It is also noted that the structural features of the metallic adjustable stand in FIGS. 1-10 are, in most cases, similar to or functionally the same as the structural features of the non-metallic adjustable stand illustrated in FIGS. 11-21. Significant functional or structural differences between the metallic adjustable stand illustrated in FIGS. 1-10 and the non-metallic adjustable stand illustrated in FIGS. 11-21 will be discussed as necessary herein.

The metallic adjustable stand illustrated in FIGS. 1-10 is generally constructed of metal, such as, but not limited to, aluminum. The parts of the metallic adjustable stand that may not be constructed of metal, if any, will be identified herein if significant. In addition, the non-metallic adjustable stand illustrated in FIGS. 11-21 is generally constructed of non-metal, such as, but not limited to plastic, ABS plastic, nylon, polycarbonate, carbon fiber, or a mixture thereof. The parts of the non-metallic adjustable stand that may not be constructed of non-metal, if any, will be identified herein if significant.

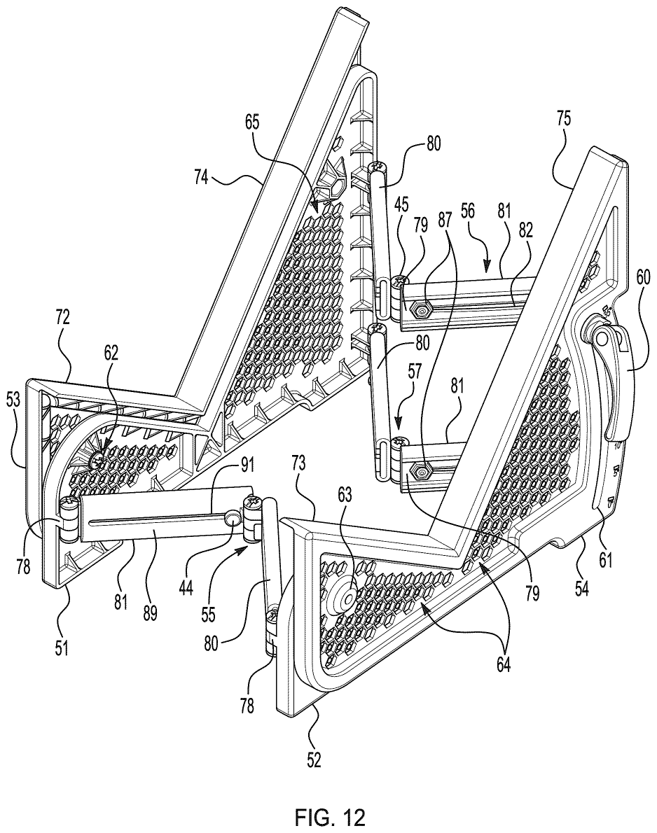

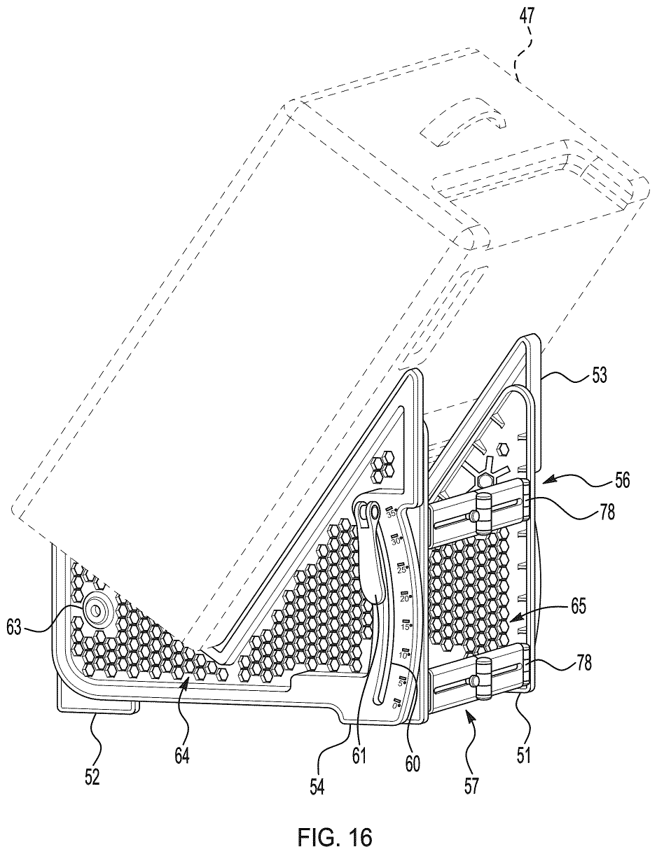

The metallic adjustable stand illustrated in FIGS. 1-10 includes a first shelf member 3 and a second shelf member 4 configured to support a speaker, an amplifier, or any other article in need of support. It is noted that FIGS. 16-18 illustrate an example of an amplifier 47 supported at different angular positions by surfaces of shelf members of the non-metallic adjustable stand illustrated in FIGS. 12-21. While this will be addressed further herebelow, it is also noted that support to the amplifier 47 provided by the surfaces of shelf members of the non-metallic adjustable stand illustrated in FIGS. 12-21 essentially corresponds to the support that would provided to the amplifier 47 if supported by the first and second shelf members 3 and 4. A first leg member 1 stands on a surface and supports the first shelf member 3. A second leg member 2 stands on the same surface as does the first leg member 3 and supports the second shelf member 4.

The first and second shelf members 3 and 4 are respectively rotatably fixed to the first and second leg member 1 and 2 at first and second rotational axles 12 and 13. The first rotational axle 12 extends through a hole 20 in the first shelf member 3 and a hole 16 in the first leg member 1 in an area corresponding with a forward portion of the metallic adjustable stand. The second rotational axle 13 extends through a hole 21 in the second shelf member 4 and a hole 17 in the second leg member 2 in an area corresponding with a forward portion of the metallic adjustable stand. Both rotational axles 12 and 13 are constructed of a combination of one or more parts or materials known by one having ordinary skill in the art to facilitate rotational fixing. Such parts or materials may be a mixture of plastic or metal screws, bolts, washers, nuts, or any other mechanism known to effectuate such rotational fixing. Both rotational axles 12 and 13 respectively allow the first and second shelf members 3 and 4 to rotate to attain an angular position.

The first and second shelf members 3 and 4 are also respectively secured to the first and second leg members 1 and 2 through the use of first and second angular position fasteners 8 and 10. The first and second angular position fasteners 8 and 10 may be respectively constructed of combinations of a cam lever and a rivet nut that fixes the cam levers to the first and second leg members 1 and 2. The use of cam levers and rivet nuts are not required, however, as other materials and hardware known to those having ordinary skill in the art can be used as long as the functionality of the angular position fasteners 8 and 10 is the same.

The first and second angular position fasteners 8 and 10 respectively extend from the first and second leg members 1 and 2 through holes 18 and 19 formed in the first and second leg members 1 and 2 and through channels 9 and 11 formed in the first and second shelf members 3 and 4. The channels 9 and 11 are curved to correspond with an arc of rotation of the first and second shelf members 3 and 4 about the rotational axles 12 and 13. The first and second angular position fasteners 8 and 10 serve to respectively lock the first and second shelf members 3 and 4 in the angular position attained through the respective rotation of the first and second shelf members 3 and 4 about the rotational axles 12 and 13.

The first and second shelf members 3 and 4 both respectively have lower shelf support surfaces 22 and 23 and upper shelf support surfaces 24 and 25 on which an article, such as the amplifier 47, can be supported. It is contemplated that the lower shelf support surfaces 22 and 23 would be used to support a bottom surface of an article, such as the amplifier 47, while the upper shelf support surfaces 24 and 25 would be used to support the rear surface of the same article.

The rotation of the first and second shelf members 3 and 4 about the rotational axles 12 and 13 moves the channels 9 and 11 with respect to the angular position fasteners 8 and 10. It is noted that the channels 9 and 11 are bounded such that the angular positions fasteners 8 and 10 extending through the channels 9 and 11 restrict the rotation of the first and second shelf members 3 and 4 about the rotational axles 12 and 13 to a specific rotation range. The angular position at which the first and second shelf members 3 and 4 are respectively locked by the angular position fasteners 8 and 10 corresponds with an angle at which the lower shelf support surfaces 22 and 23 possesses with a surface on which the first and second leg members 1 and 2 stand.

In one example of the adjustable stands disclosed herein, the corresponding angle at which the lower shelf support surfaces 22 and 23 is positioned is identified by printed angle numbering disposed adjacent to the channels 9 and 11 of the first and second shelf members 3 and 4. The angular position fasteners 8 and 10 can be used to lock the angular position of the lower shelf support surfaces 22 and 23 according to the desired angle printed adjacent to the channels 9 and 11. In embodiments described herein, the angles at which the lower shelf support surfaces 22 and 23 can be locked range from 0° to at least 35°, although it is contemplated than angles above 35° would be attainable, up to and including 180°. The upper shelf support surfaces 24 and 25 essentially maintain right angles with the lower shelf support surfaces 22 and 23 in the examples illustrated herein, although embodiments disclosed herein are not limited thereto.

In examples illustrated herein, the first and second shelf members 3 and 4 each have a rear foot that can rest on the same surface as the first and second leg members 1 and 2. Further, rubber or composite isolation feet may be added to areas of the first and second leg members 1 and 2 that are in contact with the surface on which the first and second leg members 1 and 2 are supported in case additional protection for that support surface is desired or additional sound clarity for a supported speaker or amplifier, such as amplifier 47, is desired. However, in both cases, embodiments disclosed herein are not limited thereto.

Both leg members 1 and 2 have patterned structure cutouts 14 formed therein to reduce weight and increase stiffness of the leg members 1 and 2. These patterned structure cutouts 14 are illustrated as hexagonal patterns in the drawings, but embodiments described herein are not limited thereto, as the patterned structure cutouts 14 may also include structural ribbing or other aesthetic or functional cutouts. Both shelf members 3 and 4 have patterned structure cutouts 15 formed therein to reduce weight and increase stiffness of the shelf members 3 and 4. These patterned structure cutouts 15 are illustrated as hexagonal patterns in the drawings, but embodiments described herein are not limited thereto, as the patterned structure cutouts 15 may also include structural ribbing or other aesthetic or functional cutouts.

As illustrated in FIGS. 1-10, the first and second leg members 1 and 2 are connected to each other by hinge assemblies. A front adjustable hinge assembly 5 connects a front portion of the first and second leg members 1 and 2, while an upper rear adjustable hinge assembly 6 and a lower rear adjustable hinge assembly 7 connects a rear portion of the first and second leg members 1 and 2. In an unillustrated example, it is contemplated that the rear portion of the first and second leg members 1 and 2 could be connected by only one of the adjustable hinge assemblies 6 and 7. It is also contemplated that first and second leg members 1 and 2 could be connected by more than the three adjustable hinge assemblies 5, 6, and 7. However, at the very least, connection of the rear portion of the first and second leg members 1 and 2 by both of the adjustable hinge assemblies 6 and 7 may provide additional stability and strength to the adjustable stand.

Each of the adjustable hinge assemblies 5, 6, and 7 includes a pair of first hinge members 28, a pair of second hinge members 29, a third hinge member 30, and a fourth hinge member 31. Each of the first hinge members 28 is attached to one of the first and second leg members 1 and 2 and includes a mounting plate 46 and a hinge cup 32. Each mounting plate 46 is attached to the first and second leg members 1 and 2 through convention means, such as nails, screws, or other fastening devices. It is contemplated the hinge cup 32 could be integrally formed in the first and second leg members 1 and 2.

The second hinge members 29 are respectively rotatably fastened to and extending from the first hinge members 28. The second hinge members 29 include hinge loops 33 formed at one end of an arm bar 36 and a slide stop hole 37 formed adjacent to an opposite end of the arm bar 36 from that at which the hinge loops 33 are formed. The hinge loops 33 are rotatably fastened to the hinge cup 32 of the first hinge member 28 by a fastener member 45. The slide stop hole 37 accommodates the extension of a portion of a slide stop 44 therethrough.

The third hinge member 30 accommodates the slidable fitting of one of the second hinge members 29 therein. The third hinge member 30 includes hinge loops 34 formed at one end of an arm bar 38 and facing one direction, sleeves 42 formed on opposite sides of the arm bar 38 and facing an opposite direction from the hinge loops 34, and a channel 40 formed longitudinally in the arm bar 38. The sleeves 42 accommodate the slidable fitting of the arm bar 36 of the second hinge member 29 therein. The slide stop 44 extends from a side of the arm bar 38 corresponding with the direction in which the hinge loops 34 face, through the channel 40, and through the slide stop hole 37 of the second hinge member 29.

The fourth hinge member 31 accommodates the slidable fitting of another one of the second hinge members 29 therein. The fourth hinge member 31 includes a hinge cup 35 formed at one end of an arm bar 39 and facing one direction, sleeves 43 formed on opposite sides of the arm bar 39 and facing an opposite direction from the hinge cup 35, and a channel 41 formed longitudinally in the arm bar 39. The sleeves 43 accommodate the slidable fitting of the arm bar 36 of the second hinge member 29 therein. The slide stop 44 extends from a side of the arm bar 39 corresponding with the direction in which the hinge cup faces 35, through the channel 41, and through the slide stop hole 37 of the second hinge member 29.

The third hinge member 30 is rotatably fastened to the fourth hinge member 31. Specifically, the hinge loops 34 of the third hinge member 30 are rotatably fastened to the hinge cup 35 of the fourth hinge member 31 via a fastening member 45.

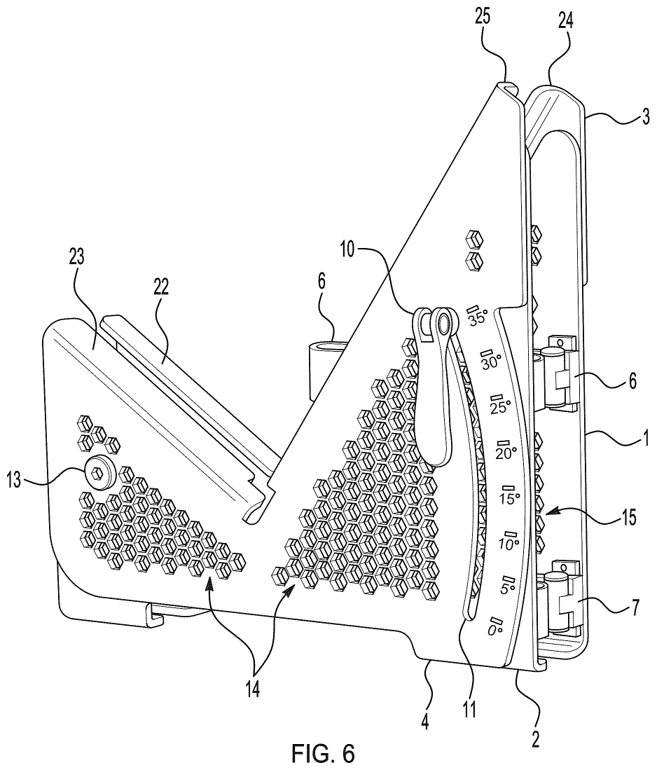

FIG. 6 illustrates an example in which the metallic stand is folded through rotation of the second hinge members 29 with respect to the first hinge members 28 toward the leg members 1 and 2 and subsequent rotation of the third hinge member 30 and the fourth hinge member 31 toward each other, thereby bringing the leg members 1 and 2 toward each other for rotatable folding.

It is noted that, in one example of the metallic stand, as illustrated in FIG. 1, the upper shelf supports 24 and 25 both include cutouts 26 and 27 formed therein. These cutouts 26 and 27 respectively accommodate the third hinge member 30 and the fourth hinge member 31 at a closer position to the leg members 1 and 2, thereby enabling thickness of the folded metallic stand to be reduced by at least one inch in comparison to different embodiments in which such cutouts 26 and 27 would not be respectively formed in the upper shelf supports 24 and 25. Examples of embodiments not included such cutouts 26 and 27 are illustrated in FIGS. 11-21 and specifically in FIG. 11.

Expansion of the metallic stand is accomplished through rotation of the second hinge members 29 with respect to the first hinge members 28 away from the leg members 1 and 2 and subsequent rotation of the third hinge member 30 and the fourth hinge member 81 away from each other, thereby bringing the leg members 1 and 2 away from each other for rotatable expansion.

It is noted that additional functionality of hinges assemblies 5, 6, and 7 will be discussed herebelow in relation to corresponding hinge assemblies 55, 56, and 57, which are illustrated in FIGS. 11-21, as the functionality of hinge assemblies 5, 6, and 7 respectively corresponds to the functionality of hinge assemblies 55, 56, and 57.

The non-metallic adjustable stand illustrated in FIGS. 11-21 includes a first shelf member 53 and a second shelf member 54 configured to support a speaker, an amplifier 47 such as is illustrated in FIGS. 16-18, or any other article in need of support. A first leg member 51 stands on a surface and supports the first shelf member 53. A second leg member 52 stands on the same surface as does the first leg member 53 and supports the second shelf member 54.

The first and second shelf members 53 and 54 are respectively rotatably fixed to the first and second leg member 51 and 52 at first and second rotational axles 62 and 63. While not illustrated, the structure of the first and second rotational axles 62 and 63 generally corresponds with the illustrated structure of the first and second rotational axles 12 and 13. For example, the first and second rotational axle 62 extends through a hole (not shown) in the first shelf member 53 and a hole (not shown) in the first leg member 51 in an area corresponding with a forward portion of the non-metallic adjustable stand. The second rotational axle 63 extends through a hole (not shown) in the second shelf member 54 and a hole (not shown) in the second leg member 52 in an area corresponding with a forward portion of the non-metallic adjustable stand. Both rotational axles 62 and 63 are constructed of a combination of one or more parts or materials known by one having ordinary skill in the art to facilitate rotational fixing. Such parts or materials may be a mixture of plastic or metal screws, bolts, washers, nuts, or any other mechanism known to effectuate such rotational fixing. Both rotational axles 62 and 63 respectively allow the first and second shelf members 53 and 54 to rotate to attain an angular position.

The first and second shelf members 53 and 54 are also respectively secured to the first and second leg members 51 and 52 through the use of first and second angular position fasteners 58 and 60. The first and second angular position fasteners 58 and 60 may be respectively constructed of combinations of a cam lever and a rivet nut that fixes the cam levers to the first and second leg members 51 and 52. The use of cam levers and rivet nuts are not required, however, as other materials and hardware known to those having ordinary skill in the art can be used as long as the functionality of the angular position fasteners 58 and 60 is the same.

While not shown in its entirety, the extension of the first and second angular position fasteners 58 and 60 through the first and second shelf members 53 and 54 and the first and second leg members 51 and 52 generally corresponds with the extension of the first and second angular position fasteners 8 and 10 through the first and second shelf members 3 and 4 and the first and second leg members 1 and 2. For example, the first and second angular position fasteners 58 and 60 respectively extend from the first and second leg members 51 and 52 through holes (not shown) formed in the first and second leg members 51 and 52 and through channels 59 and 61 formed in the first and second shelf members 53 and 54. The channels 59 and 61 are curved to correspond with an arc of rotation of the first and second shelf members 53 and 54 about the rotational axles 62 and 63. The first and second angular position fasteners 58 and 60 serve to respectively lock the first and second shelf members 53 and 54 in the angular position attained through the respective rotation of the first and second shelf members 53 and 54 about the rotational axles 62 and 63.

The first and second shelf members 53 and 54 both respectively have lower shelf support surfaces 72 and 73 and upper shelf support surfaces 74 and 75 on which an article, such as the amplifier 47, can be supported. It is contemplated that the lower shelf support surfaces 72 and 73 would be used to support a bottom surface of an article, such as the amplifier 47, while the upper shelf support surfaces 74 and 75 would be used to support the rear surface of the same article.

The rotation of the first and second shelf members 53 and 54 about the rotational axles 62 and 63 moves the channels 59 and 61 with respect to the angular position fasteners 58 and 60. It is noted that the channels 59 and 61 are bounded such that the angular positions fasteners 58 and 60 extending through the channels 59 and 61 restrict the rotation of the first and second shelf members 53 and 54 about the rotational axles 62 and 63 to a specific rotation range. The angular position at which the first and second shelf members 53 and 54 are respectively locked by the angular position fasteners 58 and 60 corresponds with an angle at which the lower shelf support surfaces 72 and 73 possesses with a surface on which the first and second leg members 51 and 52 stand.

In one example of the adjustable stands disclosed herein, the corresponding angle at which the lower shelf support surfaces 52 and 53 is positioned is identified by printed angle numbering disposed adjacent to the channels 59 and 61 of the first and second shelf members 53 and 54. The angular position fasteners 58 and 60 can be used to lock the angular position of the lower shelf support surfaces 52 and 53 according to the desired angle printed adjacent to the channels 59 and 61. In embodiments described herein, the angles at which the lower shelf support surfaces 72 and 73 can be locked range from 0° to at least 35°, although it is contemplated than angles above 35° would be attainable, up to and including 180°. The upper shelf support surfaces 74 and 75 essentially maintain right angles with the lower shelf support surfaces 72 and 73 in the examples illustrated herein, although embodiments disclosed herein are not limited thereto.

In examples illustrated herein, the first and second shelf members 53 and 54 each have a rear foot that can rest on the same surface as the first and second leg members 51 and 52. Further, rubber or composite isolation feet may be added to areas of the first and second leg members 51 and 52 that are in contact with the surface on which the first and second leg members 51 and 52 are supported in case additional protection for that support surface is desired or additional sound clarity for a supported speaker or amplifier, such as amplifier 47, is desired. However, in both cases, embodiments disclosed herein are not limited thereto.

Both leg members 51 and 52 have patterned structure cutouts 64 formed therein to reduce weight and increase stiffness of the leg members 51 and 52. These patterned structure cutouts 64 are illustrated as hexagonal patterns in the drawings, but embodiments described herein are not limited thereto, as the patterned structure cutouts 64 may also include structural ribbing or other aesthetic or functional cutouts. Both shelf members 53 and 54 have patterned structure cutouts 65 formed therein to reduce weight and increase stiffness of the shelf members 53 and 54. These patterned structure cutouts 65 are illustrated as hexagonal patterns in the drawings, but embodiments described herein are not limited thereto, as the patterned structure cutouts 65 may also include structural ribbing or other aesthetic or functional cutouts.

As illustrated in FIGS. 11-21, the first and second leg members 51 and 52 are connected to each other by hinge assemblies. A front adjustable hinge assembly 55 connects a front portion of the first and second leg members 51 and 52, while an upper rear adjustable hinge assembly 56 and a lower rear adjustable hinge assembly 57 connects a rear portion of the first and second leg members 51 and 52. In an unillustrated example, it is contemplated that the rear portion of the first and second leg members 51 and 52 could be connected by only one of the adjustable hinge assemblies 6 and 7. It is also contemplated that first and second leg members 51 and 52 could be connected by more than the three adjustable hinge assemblies 55, 56, and 57. However, at the very least, connection of the rear portion of the first and second leg members 51 and 52 by both of the adjustable hinge assemblies 56 and 57 may provide additional stability and strength to the adjustable stand.

Each of the adjustable hinge assemblies 55, 56, and 57 includes a pair of first hinge member hinge cups 78, a pair of second hinge members 79, a third hinge member 80, and a fourth hinge member 81. Each of the first hinge members hinge cups 78 is integrally formed in the first and second leg members 51 and 52.

The second hinge members 79 are respectively rotatably fastened to and extending from the first hinge member hinge cups 78. The second hinge members 79 include hinge loops 83 formed at one end of an arm bar 86, a slide stop hole 87 formed adjacent to an opposite end of the arm bar 86 from that at which the hinge loops 83 are formed, and a stiffener ribbing 82 to provide stiffness to the arm bar 86. The hinge loops 83 are rotatably fastened to the first hinge member hinge cup 78 by a fastener member 45. The slide stop hole 87 accommodates the extension of a portion of a slide stop 44 therethrough. In this particular embodiment, the slide stop hole 87 may be a molded screw holder or some similar type of mechanism known to one having skill in the art.

The third hinge member 80 accommodates the slidable fitting of one of the second hinge members 79 therein. The third hinge member 80 includes hinge loops 84 formed at one end of an arm bar 88 and facing one direction, sleeves 92 formed on opposite sides of the arm bar 88 and facing an opposite direction from the hinge loops 84, and a channel 90 formed longitudinally in the arm bar 88. The sleeves 92 accommodate the slidable fitting of the arm bar 86 of the second hinge member 79 therein. The slide stop 44 extends from a side of the arm bar 88 corresponding with the direction in which the hinge loops 84 face, through the channel 90, and through the slide stop hole 87 of the second hinge member 79.

The fourth hinge member 81 accommodates the slidable fitting of another one of the second hinge members 79 therein. The fourth hinge member 81 includes a hinge cup 85 formed at one end of an arm bar 89 and facing one direction, sleeves 93 formed on opposite sides of the arm bar 89 and facing an opposite direction from the hinge cup 85, and a channel 91 formed longitudinally in the arm bar 89. The sleeves 93 accommodate the slidable fitting of the arm bar 86 of the second hinge member 79 therein. The slide stop 44 extends from a side of the arm bar 89 corresponding with the direction in which the hinge cup faces 85, through the channel 91, and through the slide stop hole 37 of the second hinge member 79.

The third hinge member 80 is rotatably fastened to the fourth hinge member 81. Specifically, the hinge loops 84 of the third hinge member 80 are rotatably fastened to the hinge cup 85 of the fourth hinge member 81 via a fastening member 45.

FIGS. 11, 12, and 15 illustrate examples in which the non-metallic stand is folded through rotation of the second hinge members 79 with respect to the first hinge member hinge cups 78 toward the leg members 51 and 52 and subsequent rotation of the third hinge member 80 and the fourth hinge member 81 toward each other, thereby bringing the leg members 51 and 52 toward each other for rotatable folding.

Expansion of the non-metallic stand is accomplished through rotation of the second hinge members 79 with respect to the first hinge member hinge cups 78 away from the leg members 51 and 52 and subsequent rotation of the third hinge member 80 and the fourth hinge member 81 away from each other, thereby bringing the leg members 51 and 52 away from each other for rotatable expansion.

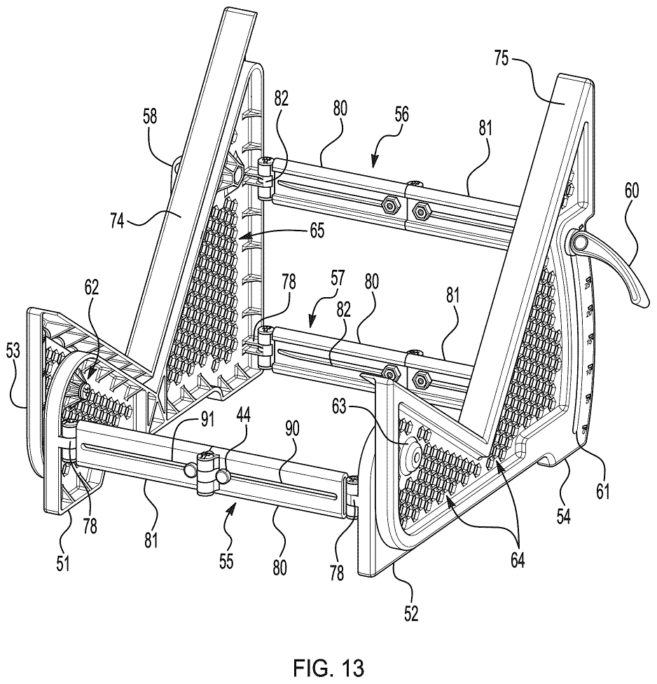

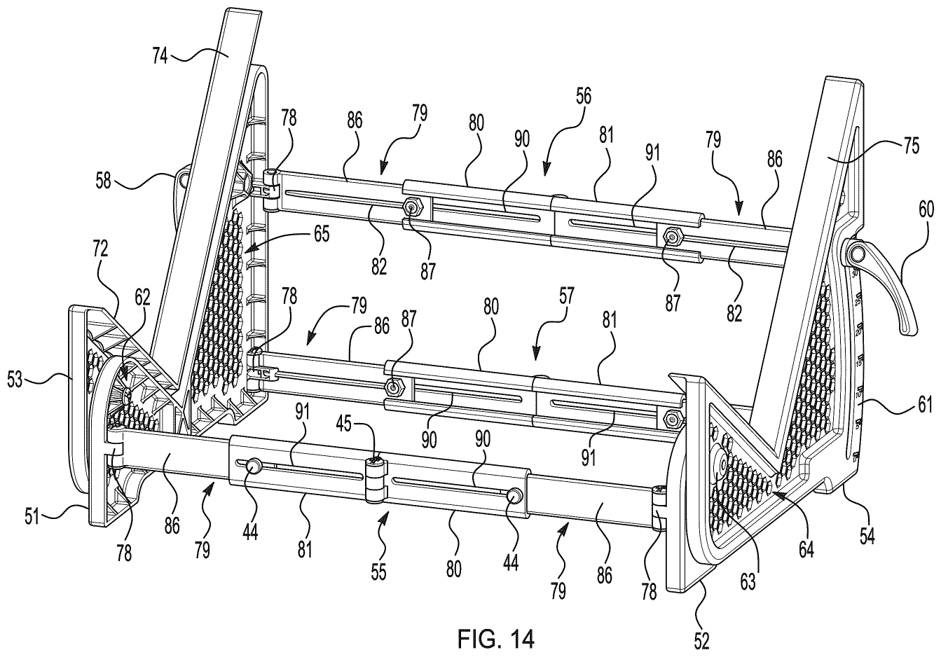

FIG. 14 illustrates an example of the sliding of the second hinge members 79 in the third and fourth hinge members 80 and 81 to slidably adjust the respective width between the leg members 51 and 52 when the adjustable hinge assemblies 55, 56, and 57 are rotatably expanded as illustrated in FIG. 13. The example illustrated in FIG. 14 with respect to the functionality of the adjustable hinge assemblies 55, 56, and 57 corresponds with the functionality of the adjustable hinge assemblies 5, 6, and 7.

Specifically, if tightened, the slide stops 44 are loosened, allowing the second hinge members 79 to respectively slide within the third and fourth hinge members 80 and 81. The extent to which the second hinge members 79 are permitted to slide are controlled by the channels 90 and 91 through which the slide stops 44 extend. After achieving the desired width extension, the slide stops 44 are tightened.

Initial operation of the adjustable stand illustrated in FIGS. 11-21, as well as the stand illustrated in FIGS. 1-10, begins with the unfolding of the stand by expanding the hinge assemblies 55, 56, and 57 until the leg members 51 and 52 and the shelf members 53 and 54 are perpendicular to the surface on which the leg members 51 and 52 are to be placed and parallel with each other. The leg members 51 and 52 are then placed on the aforementioned surface. The width is then adjusted by sliding the second hinge members 79 within the third and fourth hinge members 80 and 81 and fixed by securing the slide stops 44.

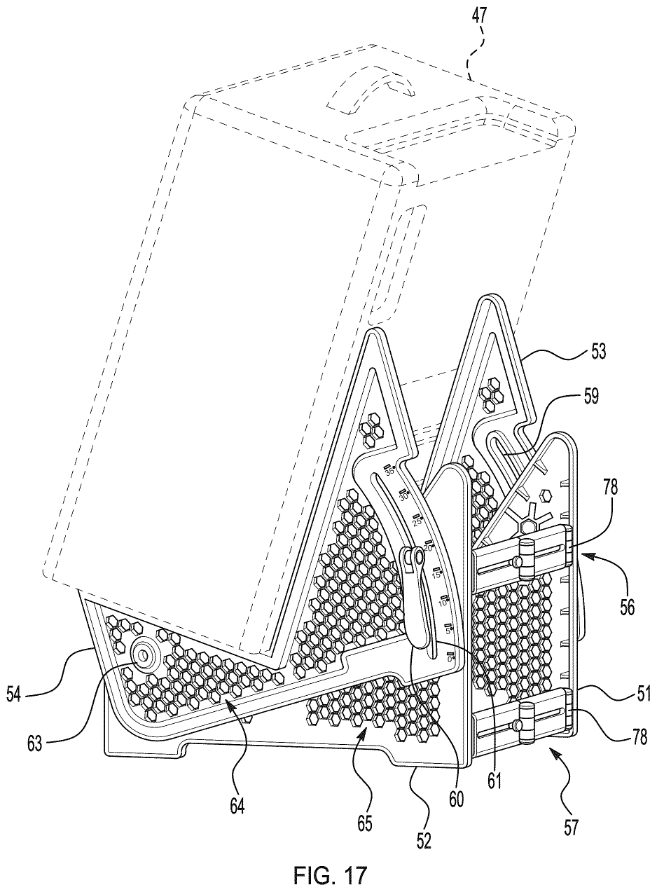

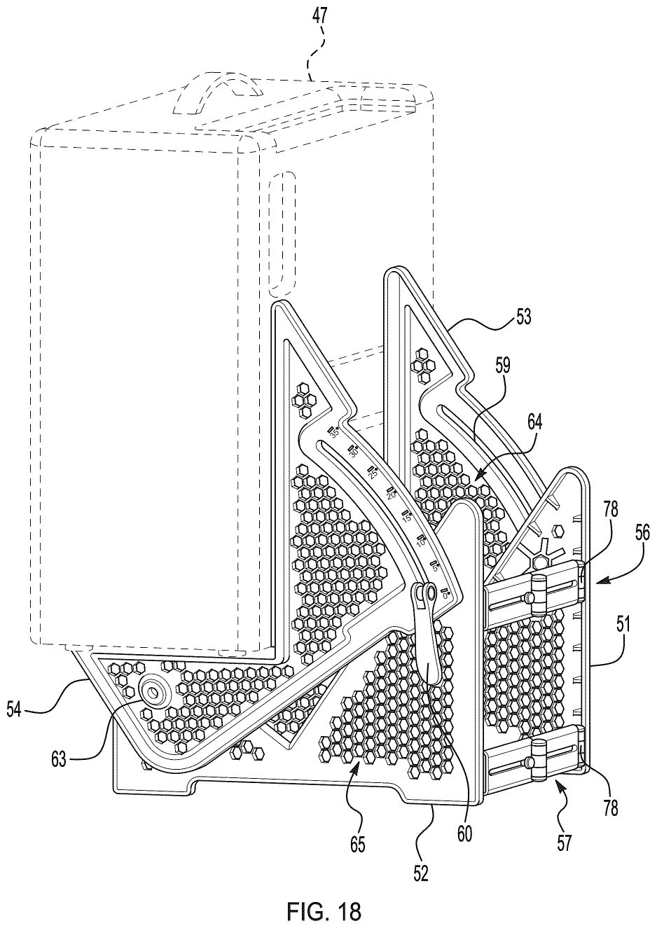

The article, such as the amplifier 47 illustrated in FIGS. 16-18, is then lowered onto the surfaces of the shelf support 72, 73, 74, and 75. The angle at which the article, or the amplifier 47, is tilted is adjusted by unfastening the angular position fasteners 58 and 60 and rotating the shelf members 53 and 54 with respect to the leg members 51 and 52 until the desired tilting position or sound projection is attained, at which time the angular position fasteners 58 and 60 are fastened. FIG. 16 illustrates an example of the amplifier 47 being seated on the shelf members 53 and 54 at an angular position of 35°. FIG. 17 illustrates an example of the amplifier 47 being seated on the shelf members 53 and 54 at an angular position of 17°. FIG. 18 illustrates an example of the amplifier 47 being seated on the shelf members 53 and 54 at an angular position of 0°.

The foldable and adjustable stands described herein support a range of amplifier and speaker sizes with full angular and width adjustability. It is fully contemplated that the foldable and adjustable stands described herein could be used to support structures other than speakers or amplifiers. The stands include features that isolate the supported equipment from the ground and, if supporting speakers or amplifiers, allow precise directional control of sound projection. The stands are capable of being manufactured in multiple materials and versions to suit different use cases, performance needs, and cost requirements. When not in use, the stands fold in an accordion style into a compact form for convenient storage and transport having a thickness contemplated at being in range between 2.5″ and 3.5″, although embodiments disclosed herein are not limited thereto.

The stands include adjustable legs and shelves connected via a multi-hinged structure that allows for both expansion and angular movement. Articles, such as amplifier 47, are held securely and can be tilted from a base angle (0°) up to at least 35°, with design variants permitting up to 180° of rotation. The width of stands between leg members is adjustable using a multi-hinge configuration that can allow a 12″ stand width to be expanded to a 19″ or greater stand width, although embodiment disclosed herein are not limited thereto. Locking devices, such as thumb screws or other mechanisms known to those having ordinary skill in the art, can lock the hinge configuration for the desired stand width, although the stands remain functional without locking.

The foregoing description is a specific embodiment of the present invention. It should be appreciated that this embodiment is described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

1. An adjustable stand for supporting an article, comprising:
a pair of shelf members configured to support the article;
a pair of leg members including a first leg member and a second leg member, the pair of leg members being configured to stand on a surface, each of the leg members being configured to support one of the shelf members; and
a width-adjustment mechanism configured to adjust widths between the pair of leg members, the width-adjustment mechanism comprising two or more adjustable hinge assemblies connecting the pair of leg members, each of the adjustable hinge assemblies being configured to rotatably expand to space the leg members from each other, rotatably fold to bring the leg members toward each other, and slidably adjust a respective width between the leg members when the adjustable hinge assemblies are rotatably expanded,
wherein each of the adjustable hinge assemblies comprises:
a pair of first hinge members respectively attached to the first leg member and the second leg member;
a pair of second hinge members respectively rotatably fastened to and extending from the first hinge members;
a third hinge member into which one of the second hinge members is slidably fitted; and
a fourth hinge member into which another one of the second hinge members is slidably fitted, the fourth hinge member being rotatably fastened to the third hinge member.

2. The stand according to claim 1, wherein each of the leg members comprises a rotational axle at which the supported one of the shelf members is attached and about which the supported one of the shelf members is configured to rotate to attain an angular position,
wherein angular position fasteners are respectively attached to the leg members and respectively extend through channels formed in the shelf members, and
wherein the angular position fasteners are configured to lock the shelf members in the angular position.

3. The stand according to claim 2, wherein each of the shelf members comprises a lower shelf support and an upper shelf support, the lower shelf support being configured to support a bottom surface of the article, the upper shelf support being configured to support a rear surface of the article, and
wherein an angular position of the lower shelf support with respect to the surface on which the leg members stand is at an angle in a range from 0° to at least 35°.

4. The stand according to claim 1, wherein the shelf members and leg members are constructed of plastic, metal, carbon fiber, or a combination thereof.

5. The stand according to claim 1, wherein the shelf members and leg members comprise a plurality of patterned structural cutouts configured to reduce respective weights of the shelf members and the leg members.

6. The stand according to claim 1, wherein the width-adjustment mechanism further comprises three or more adjustable hinge assemblies.

7. (canceled)

8. The stand according to claim 1, wherein the third hinge member and the fourth hinge member are configured to rotate towards each other to bring the leg members toward each other for rotatable folding and rotate away from each other to space the leg members from each other for rotatable expansion.

9. The stand according to claim 1, wherein the second hinge members are configured to respectively slide in the third and fourth hinge members to slidably adjust the respective width between the leg members when the adjustable hinge assemblies are rotatably expanded.

10. The stand according to claim 9, wherein channels are respectively formed in the third and fourth hinge members,
wherein slide stops are attached to each of the second hinge members and extend through the third and fourth hinge members, and
wherein the slide stops are configured to lock the sliding of the second hinge members.

11. The stand according to claim 1, wherein a plurality of patterned structural cutouts are formed in each of the shelf members and the leg members.
